(19) United States
(12) Patent Application Publication
(10) Pub. No.: US 2014/0306963 A1
(43) Pub. Date: Oct. 16, 2014

(54) USE MOTION PARALLAX TO CREATE 3D PERCEPTION FROM 2D IMAGES

(71) Applicants: Wei Sun, San Jose, CA (US); Kieran Del Pasqua, Toronto (CA)

(72) Inventors: Wei Sun, San Jose, CA (US); Kieran Del Pasqua, Toronto (CA)

(21) Appl. No.: 13/977,443

(22) PCT Filed: Sep. 12, 2011
(86) PCT No.: PCT/US11/51197

§ 371 Date: May 12, 2014

(51) Int. Cl. G06T 15/08

(52) U.S. Cl. CPC G06T 15/08
USPC 345/427

(57) ABSTRACT

Systems, devices and methods are described including receiving multiple two-dimensional (2D) images of a scene, using the 2D images to determine three-dimensional (3D) information associated with the scene, and determining a user viewing angle with respect to a display. The 3D information and the user viewing angle may then be used to present a generated image on the display. If the user moves with respect to the display then a correspondingly new user viewing angle may be determined and, using the 3D information and the new user viewing angle, a different generated image may be displayed.

### BACKGROUND

From a user's point of view, motion parallax viewing techniques provide 3D perception of a 3D scene without requiring special viewing devices such as stereoscopic display devices, shuttle glasses, polarized glasses, and the like. Because the user's experience is equivalent to looking at the scene in a mirror or through the window, motion parallax viewing tends to not cause effects such as eye strain that are commonly associated with using special viewing devices. To date, the motion parallax effect has been used only for viewing 3D virtual content generated by computer graphics, but has not been employed for viewing 2D photo and/or video content captured by cameras. Employing motion parallax effect for viewing 2D photos and videos involves the extraction of 3D information from a real life scene during anchor after image capture.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIGS. 1 and 2 are illustrative diagrams of example parallax viewing systems;

FIG. 3 illustrates an example parallax viewing process;

FIG. 4 is an illustrative diagram of a example camera viewpoints;

FIG. 5 illustrates an example parallax viewing scheme;

FIG. 6 illustrates an example parallax viewing process;

FIG. 7 is an illustrative diagram of an example system; and

FIG. 8 illustrates an example parallax viewing process, all arranged in accordance with at least some implementations of the present disclosure.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to effect such feature, structure, or characteristic in connection with other implementations whether or not explicitly described herein.

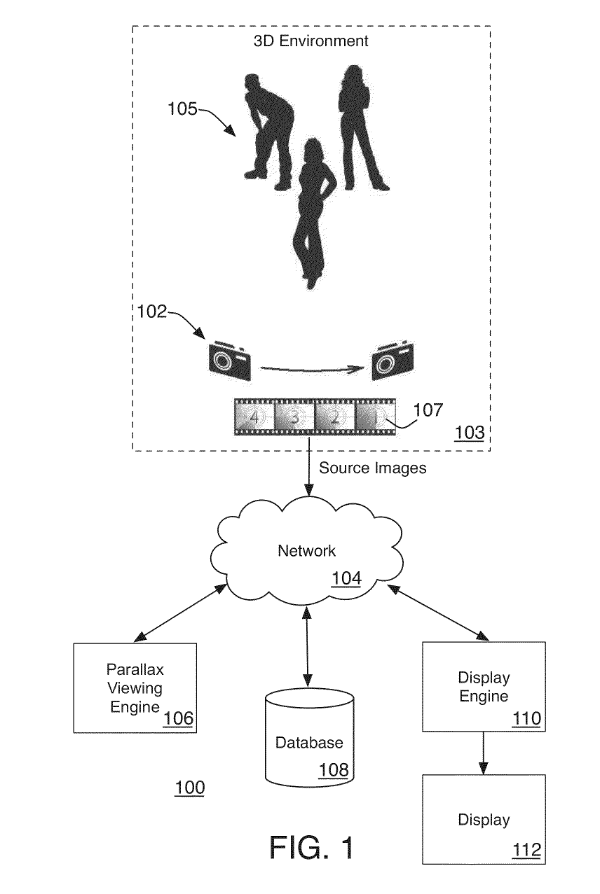

FIG. 1 illustrates an example motion parallax viewing system 100 in accordance with the present disclosure. In various implementations, system 100 may include an imaging device 102, such as a video capable camera, providing source images 107 in the form of two-dimensional (2D) video images. In various implementations, imaging device 102 may be any type of device, such as a video capable smart phone or the like, capable of providing 2D video images 107 in digital form. Source images 107 may have any resolution and/or aspect ratio. Source images 107 may be stored locally on the imaging device 102 or may be transmitted through a network 104. Network 104 may be any type of network and may include any combination of wireless and/or wired network technology. For instance, in a non-limiting example, network 104 may include one or more wireless local area networks (LANs) (e.g., servicing 3D environment 103) in combination with a wide area network (WAN), such as the internet.

As shown in FIG. 1, when capturing video images 107, motion of camera 102 horizontally with respect to scene 105 may generate captured video source images 107 having various orientations or view angles with respect to scene 105. In various implementations, any approach may be employed to move camera 102 horizontally with respect to scene 105. For example, while in video mode, camera 102 may be moved manually (e.g., by hand) to obtain source images 107 having different view angles. In other implementations, camera 102 may automatically obtain source images 107 with different view angles. For example, camera 102 may incorporate a lens/imaging system that automatically obtains source images 107 with different view angles using any internal mechanical control scheme so that a user need only engage the shutter control once and does not need to move the camera manually to obtain source images 107.

System 100 also includes a motion parallax viewing engine 106, a database 108 and a display engine 110, all communicatively coupled to each other directly or via network 104. In various implementations, as will be explained in greater detail below, parallax viewing engine 106 may receive source images 107 via network 104 and may perform various processes on those images to obtain 3D information such as view angles associated with the various images. Parallax viewing engine 106 may store the 3D information associated with the source images 107 in database 108. In various implementations, as will be explained in greater detail below, display engine 110 may receive source images 107 and associated 3D information from the imaging device 102 directly or via network 104 and may undertake various processes to provide images for presentation on a display 112 that depend on a user's viewing angle with respect to display 112.

FIG. 2 illustrates another example parallax viewing system 200 in accordance with the present disclosure. In various implementations, system 200 may include at least two imaging devices (e.g., cameras) 202 and 204 providing respective 2D source images 206 and 208 of scene 105 to network 104. In various implementations, devices 202 and 204 may be any type of device, such as a smart phone or the like, capable of providing 2D images in digital form to network 104. Source images 206 and 208 may have any resolution and/or aspect ratio. In various implementations, devices 202 and 204 may be calibrated using known techniques (see, e.g., H Malm and A. Heyden, “Simplified intrinsic Camera Calibration and Hand-Eye Coordination for Robot Vision,” Proceedings of the 2003 IEEE/RSJ Intl. Conference on Intelligent Robots and Systems (October, 2003)).

As shown in FIG. 2, imaging devices 202 and 204 are spaced apart from each other and have corresponding orientation or view angles Θ₁ and Θ₂ with respect to scene 105. As a result, the respective images 206 and 208 may capture scene 105 from the different perspectives according to the different view angles Θ₁ and Θ₂. In various implementations, the distance x or baseline between imaging devices 202 and 204 may depend on the depth or distance d between imaging devices 202 and 204 and scene 105. For instance, in a non-limiting example, if the depth d between imaging devices 202 and 204 and scene 105 is about two meters, then a baseline of about ten centimeters between imaging devices 202 and 204 may provide images 206 and 208 with different perspectives of scene 105 suitable for stereo reconstruction techniques as will be explained in greater detail below.

In various implementations, the two imaging devices 202 and 204 may be similar devices. For instance, in some implementations, devices 202 and 204 may be similar high-resolution color cameras. In yet other implementations, devices 202 and 204 may be similar color-depth cameras such as structured light cameras or time-of-flight cameras. In yet further implementations, the two imaging devices 202 and 204 may be dissimilar devices. For instance, in some implementations, device 202 may be a high-resolution color camera while device 204 may be a wide field-of-view camera equipped, for example, with a fisheye lens.

System 200 also includes parallax viewing engine 106, database 108 and display engine 110, all communicatively coupled to network 104 and to each other via network 104. In various implementations, as will be explained in further detail below, parallax viewing engine 106 may receive source images 206 and 208 via network 104 and may perform various processes such as stereo reconstruction on those images to obtain 3D information associated with scene 105. Parallax viewing engine 106 may store the 3D information in database 108. In various implementations, as will be explained in greater detail below, display engine 110 may receive the 3D information via network 104 and may undertake various processes to provide synthesized images of scene 105 that depend on a user's viewing angle with respect to display 112.

While FIGS. 1 and 2 illustrate engines 106 and 110 and database 108 as separate from each other, the present disclosure is not limited to such arrangements. For example, in some implementations, engines 106 and 110 and/or database 108 may be provided by a single device or computing system such as a server. Further, in some implementations, for example in system 100, viewing engine 106 and camera 102 may be included in a single device or computing system such as a smart phone. Further, in yet other implementations, rather than only two imaging devices 202 and 204, system 200 may include multiple image capturing devices (e.g., camera elements) spaced apart from each other horizontally so that multiple images of scene 105 may be captured simultaneously from more than two view angles. The foregoing are just a few example arrangements of the items of systems 100 and 200 and numerous other arrangements or implementations are possible consistent with the present disclosure.

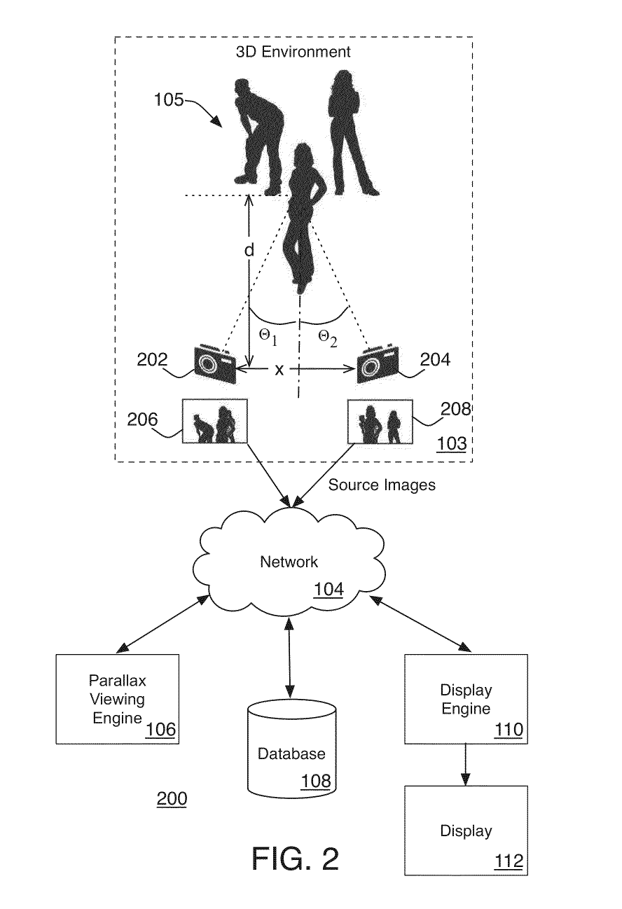

FIG. 3 illustrates a flow diagram of an example parallax viewing process 300 according to various implementations of the present disclosure. Process 300 may include one or More operations, functions or actions as illustrated by one or more of blocks 302, 304, 306, 308, 310, 312 and 314 of FIG. 3. By way of non-limiting example, process 300 will be described herein with reference to example system 100 of FIG. 1.

Process 300 may begin at block 302 where multiple source video images 301 may be received. For example, referring to system 100, block 302 may involve parallax viewing engine 106 receiving source images 107 via network 104. In some implementations, the source images may be received from database 108 at block 302.

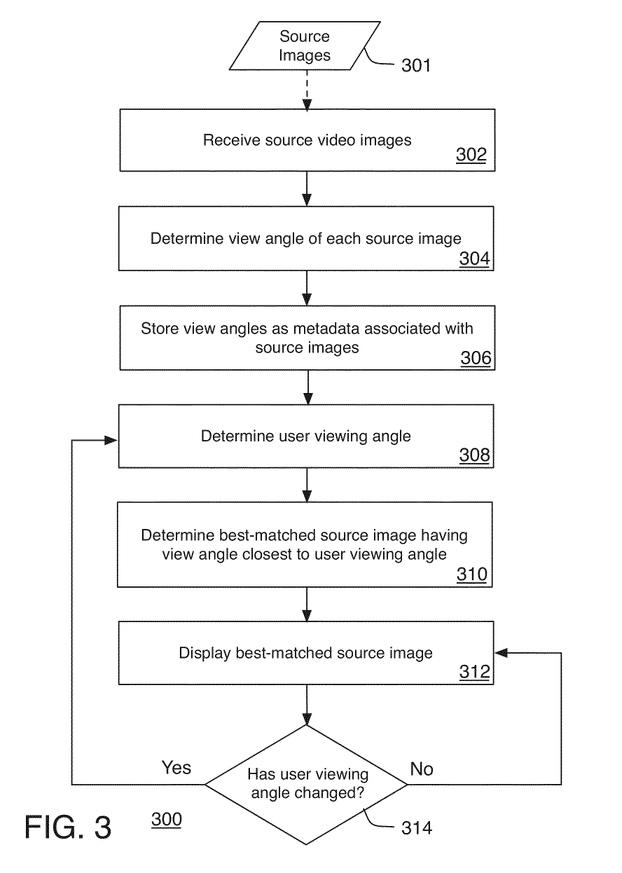

View angles of the source images may then be determined at block 304. In various implementations, block 304 may involve parallax viewing engine 106 using known techniques (see, e.g., M. Goesele et al., “Multi-View Stereo for Community Photo Collections,” IEEE 11th International Conference on Computer Vision (2007)) to determine the view angle of each image received at block 302. For example, FIG. 4 illustrates a simplified example diagram 400 of several camera viewpoints 402-405 of source images with respect to a center point 406 and associated central axis 407 of scene 105. As shown in diagram 400, block 304 may include determining a view angle 408 of viewpoint 402, a view angle 410 of viewpoint 403, and so forth. In various implementations, view angles to the left of axis 407 such as view angles 408 and 410 may be designated as negative valued view angles, while view angles to the right of axis 407, such as view angle 412 of viewpoint 405, may be designated as positive valued view angles.

Returning to discussion of process 300, the view angles determined at block 304 may be stored as metadata associated with the corresponding source images (block 306). For instance, in various implementations, having determined view angles at block 304, parallax viewing engine 106 may undertake block 306 by storing view angle metadata in database 108 in such a manner that the view angle metadata is associated with the corresponding source images in database 108.

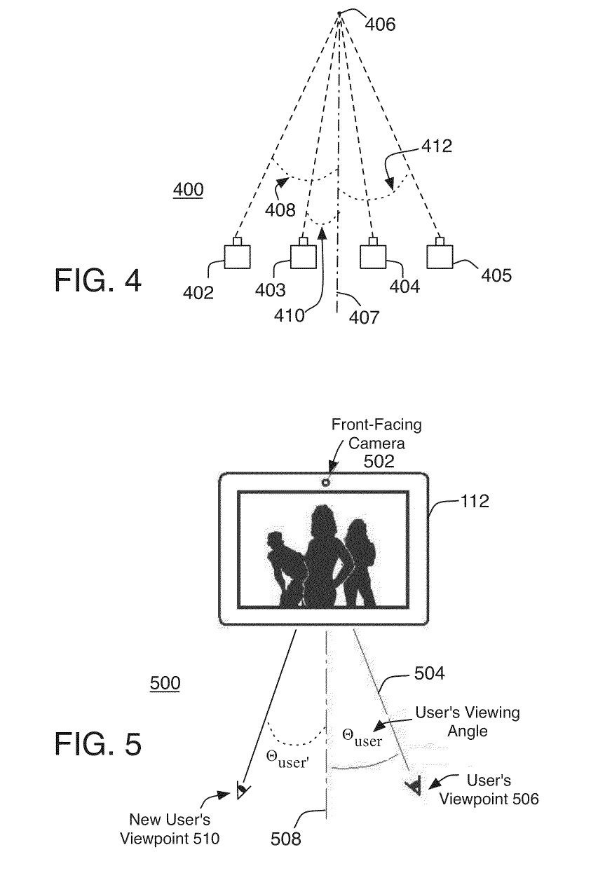

At block 308, a user viewing angle may be determined. In various implementations, block 308 may involve a mechanism associated with a display, such as a front-facing camera and associated logic, determining the angle of a user with respect to the display where the display is to be used to present images of scene 105 to the user. For example, FIG. 5 illustrates a simplified example diagram 500 including display 112 of systems 100 and 200. Display 112 includes a front-facing camera 502 and associated logic (not shown) that may employ known techniques to detect a user's face and/or head and thereby determine a user's viewing angle Θᵤₛₑᵣ. The user viewing angle Θᵤₛₑᵣ may be determined as the angular difference between a user's line of sight 504 associated with a user's viewpoint 506, as established using face/head recognition techniques, and a central axis 508 of display 112. In various implementations, display engine 110 of system 100 may undertake block 308. Further, user viewing angles to the right of central axis 508 may be designated as having positive values while angles to the left of central axis 508 may be designated as negative values.

Returning to discussion of process 300, a best-matched source image having a view angle closest to the user viewing angle may be determined (block 310). In various implementations, block 308 may involve display engine 110 accessing the view angle metadata resulting from block 306 and comparing the corresponding view angles to the user viewing angle determined at block 308 to determine a best-matched source image corresponding to an image view angle closest in value to the user viewing angle. In undertaking block 310, display engine 110 may access view angle metadata stored in database 108.

At block 312, the best-matched source image may be displayed. For example, having determined the best-matched source image at block 310, display engine 110 may present that source image on display 112. In undertaking block 312, display engine 110 may retrieve the corresponding source image from database 108.

At block 314, a determination may be made as to whether the user viewing angle has changed. For example, referring also to FIG. 5, block 314 may involve determining that the user has moved with respect to display 112 such that the user is now positioned at a new user's viewpoint 510. As a result, process 300 may return to block 308 where a new user viewing angle Θᵤₛₑᵣ, may be determined in a similar manner to that described above. Subsequently, blocks 310 and 312 may again be undertaken to determine a new best-matched source image and to display that new best-matched source image in a manner similar to that described above. If it is determined that the new user viewpoint has not changed sufficiently to result in a new best-matched source image, process 300 may return to block 312 to continue displaying the current best-matched source image. In this manner, process 300 may provide for a user-steerable 3D perception or viewing experience.

While block 308, as described above, employs a front-facing camera to determine a user viewing angle, the present disclosure is not limited to particular methods for determining a user viewing angle. For instance, other techniques that may be employed to determine user viewing angle include using well known mouse, keyboard, and/or touch screen user control techniques. For instance, a user viewing angle determination may be made as a result of a user's interaction with a touch screen computing system. For example, a user viewing angle may be indicated by a user touching a particular location on a touch screen. Further, the user touching the screen and then sliding their finger in a particular direction and so forth may indicate a change in user viewing angle.

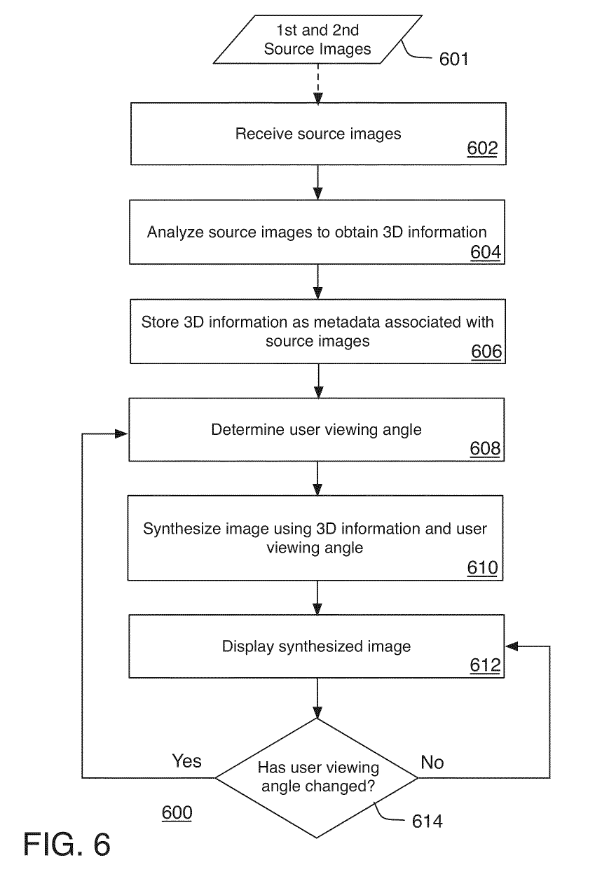

FIG. 6 illustrates a flow diagram of an example parallax viewing process 600 according to various implementations of the present disclosure. Process 600 may include one or more operations, functions or actions as illustrated by one or more of blocks 602, 604, 606, 608, 610, 612 and 614 of FIG. 6. By way of non-limiting example, process 600 will be described herein with reference to example system 200 of FIG. 2.

Process 600 may begin at block 602 where at least a pair of source images may be received. For example, referring to system 200, block 602 may involve parallax viewing engine 106 receiving first and second source images 206 and 208 via network 104. In some implementations, the source images may be received from database 108 at block 602.

As noted above in the discussion of FIG. 2, imaging devices 202 and 204 may be similar devices and, hence, source images 206 and 208 may also be similar. For instance, in implementations where devices 202 and 204 are similar high-resolution color cameras, source images 206 and 208 may be high-resolution color images having similar data formats, resolutions and aspect ratios. In yet other implementations where devices 202 and 204 are similar color-depth cameras such as structured light cameras or time-of-flight cameras, source images 206 and 208 may be high-resolution color images having similar data formats (including depth data), resolutions and aspect ratios.

By contrast, in implementations where imaging devices 202 and 204 are dissimilar, source images 206 and 208 may likewise be dissimilar. For instance, in implementations where device 202 is a high-resolution color camera and device 204 is a wide field-of-view camera, source image 206 may be a high-resolution color image while source, image 208 may be a lower resolution, wide field-of-view color image. In such implementations, images 206 and 208 may have similar aspect ratios but may capture different portions or aspects of scene 105. For instance, image 206 may be a high-resolution color image that provides high-resolution visual details in the middle of the field-of-view of scene 105 while fisheye image 208 may provide a lower resolution peripheral view of scene 105.

At block 604, the source images may be analyzed to obtain 3D information of scene 105. In various implementations, where the source images are obtained from similar, calibrated imaging devices, block 604 may include extracting 3D information of scene 105 and estimating camera motion such as rotation and translation between the source images using known stereo reconstruction techniques (see, e.g., Seitz et al., “A Comparison and Evaluation of Multi-View Stereo Reconstruction Algorithms,” in Proc. IEEE Conf. on Computer Vision and Pattern Recognition (2006)). In various implementations, the 3D information generated at block 604 and associated with the source images received at block 602 may include 3D coordinates of the scene (e.g., for scene feature points in the scene's world coordinate system) as well as camera pose information associated with the two source images.

In undertaking block 604, camera view angles of the two source images 206 and 208 may be used as left-most and right-most reference view angles. In some implementations, where, for example, the source images are obtained from color-depth imaging devices, depth data in the source images may also be employed to aid in the extraction of 3D information from texture-less scenes or in implementations where the baseline between the imaging devices is large enough to preclude reliable stereo reconstruction of the scene. At block 606, the 3D information may be stored as metadata associated with the source images. For example, 3D information may be stored as metadata in database 108 of system 200. In various implementations, blocks 602-606 of process 600 may be undertaken by parallax viewing engine 106.

At block 608, a user viewing angle may be determined. For example, block 608 may be undertaken in a manner similar to that described herein with respect to block 308 of process 300. As noted previously with respect to block 308, a user viewing angle may be determined using a front-facing camera on display 112 or in response to user manipulation of a mouse, keyboard, touch screen or the like.

At block 610, an image may be synthesized based, at least in part, on the 3D information determined at block 604 and the user viewing angle determined at block 608, in various implementations, block 610 may include using known techniques to project the 3D information to generate an image of scene 105 having a perspective corresponding to the user's viewing angle with respect to display 112. The resulting synthesized image may then be displayed at block 612. For example, the synthesized image may be rendered or presented on display 112.

At block 614, a determination may be made as to whether the user viewing angle has changed. For example, referring again to FIG. 5, block 614 may involve determining that the user has moved with respect to display 112 such that the user is now positioned at a new user's viewpoint 510. As a result, process 600 may return to block 608 where a new user viewing angle Θᵤₛₑᵣ, may be determined in a similar manner to that described above. Subsequently, blocks 610 and 612 may again be undertaken, in a manner similar to that described above, to synthesize a new image of scene 105 having a perspective corresponding to the new user viewing angle. If it is determined that the new user viewpoint has not changed sufficiently, process 600 may return to block 612 to continue displaying the current synthesized image. In this manner, process 600 may provide for a user-steerable 3D perception or viewing experience, in various implementations, blocks 608-614 of process 600 may be undertaken by display engine 110.

While the implementation of example processes 300 and 600, as illustrated in FIGS. 3 and 6, may include the undertaking of all blocks shown in the order illustrated, the present disclosure is not limited in this regard and, in various examples, implementation of processes 300 and 600 may include the undertaking only a subset of blocks shown and/or in a different order than illustrated. Further, portions of processes 300 and/or 600 may be undertaken at different junctures. For example, blocks 302-306 of FIG. 3 or blocks 602-606 of FIG. 6 may be undertaken by parallax viewing engine 106 and the results of those actions stored in database 108. Subsequently, at a later time (e.g., days, weeks or months later) display engine 110 may undertake blocks 308-314 of FIG. 3 or blocks 608-614 of FIG. 6.

In addition, any one or more of the processes and/or blocks of FIGS. 3 and 6 may be undertaken in response to instructions provided by one or more computer program products. Such program products may include signal bearing media providing instructions that, when executed by, for example, one or more processor cores, may provide the functionality described herein. The computer program products may be provided in any form of computer readable medium. Thus, for example, a processor including one or more processor core(s) may undertake one or more of the blocks shown in FIGS. 3 and 6 in response to instructions conveyed to the processor by a computer readable medium.

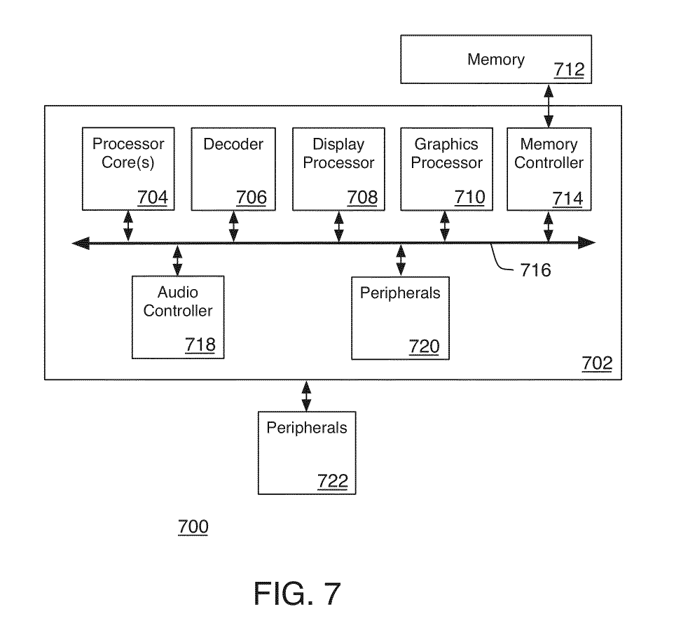

FIG. 7 illustrates an example system 700 in accordance with the present disclosure. System 700 may be used to perform some or all of the various functions discussed herein and may include any device or collection of devices capable of implementing parallax viewing in accordance with various implementations of the present disclosure. For example, system 700 may include selected components of a computing platform or device such as a desktop, mobile or tablet computer, a smart phone, a set top box, etc., although the present disclosure is not limited in this regard. In some implementations, system 700 may be a computing platform or SoC based on Inter architecture (IA) for CE devices. It will be readily appreciated by one of skill in the art that the implementations described herein can be used with alternative processing systems without departure from the scope of the present disclosure.

System 700 includes a processor 702 having one or more processor cores 704. Processor cores 704 may be any type of processor logic capable at least in part of executing software and/or processing data signals. In various examples, processor cores 704 may include CISC processor cores, RISC microprocessor cores, VLIW microprocessor cores, and/or any number of processor cores implementing any combination of instruction sets, or any other processor devices, such as a digital signal processor or microcontroller.

Processor 702 also includes a decoder 706 drat may be used for decoding instructions received by, e.g., a display processor 708 and/or a graphics processor 710, into control signals and/or microcode entry points. While illustrated in system 700 as components distinct from core(s) 704, those of skill in the art may recognize that one or more of core(s) 704 may implement decoder 706, display processor 708 and/or graphics processor 710. In some implementations, processor 702 may be configured to undertake any of the processes described herein including the example processes described with respect to FIGS. 3 and 6. Further, in response to control signals and/or microcode entry points, decoder 706, display processor 708 and/or graphics processor 710 may perform corresponding operations.

Processing core(s) 704, decoder 706, display processor 708 and/or graphics processor 710 may be communicatively and/or operably coupled through a system interconnect 716 with each other and/or with various other system devices, which may include but are not limited to, for example, a memory controller 714, an audio controller 718 and/or peripherals 720. Peripherals 720 may include, for example, a unified serial bus (USB) host port, a Peripheral Component Interconnect (PCI) Express port, a Serial Peripheral Interface (SPI) interface, an expansion bus, and/or other peripherals. While FIG. 7 illustrates memory controller 714 as being coupled to decoder 706 and the processors 708 and 710 by interconnect 716, in various implementations, memory controller 714 may be directly coupled to decoder 706, display processor 708 and/or graphics processor 710.

In some implementations, system 700 may communicate with various I/O devices not shown in FIG. 7 via an I/O bus (also not shown). Such I/O devices may include but are not limited to, for example, a universal asynchronous receiver/transmitter (UART) device, a USB device, an I/O expansion interface or other I/O devices. In various implementations, system 700 may represent at least portions of a system for undertaking mobile, network and/or wireless communications.

System 700 may further include memory 712. Memory 712 may be one or More discrete memory components such as a dynamic random access memory (DRAM) device, a static random access memory (SRAM) device, flash memory device, or other memory devices. While FIG. 7 illustrates memory 712 as being external to processor 702, in various implementations, memory 712 may be internal to processor 702. Memory 712 may store instructions and/or data represented by data signals that may be executed by processor 702 in undertaking any of the processes described herein including the example processes described with respect to FIGS. 3 and 6. In some implementations, memory 712 may include a system memory portion and a display memory portion.

The devices and/or systems described herein, such as example systems 100, 200 and/or 700 represent several of many possible device configurations, architectures or systems in accordance with the present disclosure. Numerous variations of systems such as variations of example systems 100, 200 and/or 700 are possible consistent with the present disclosure.

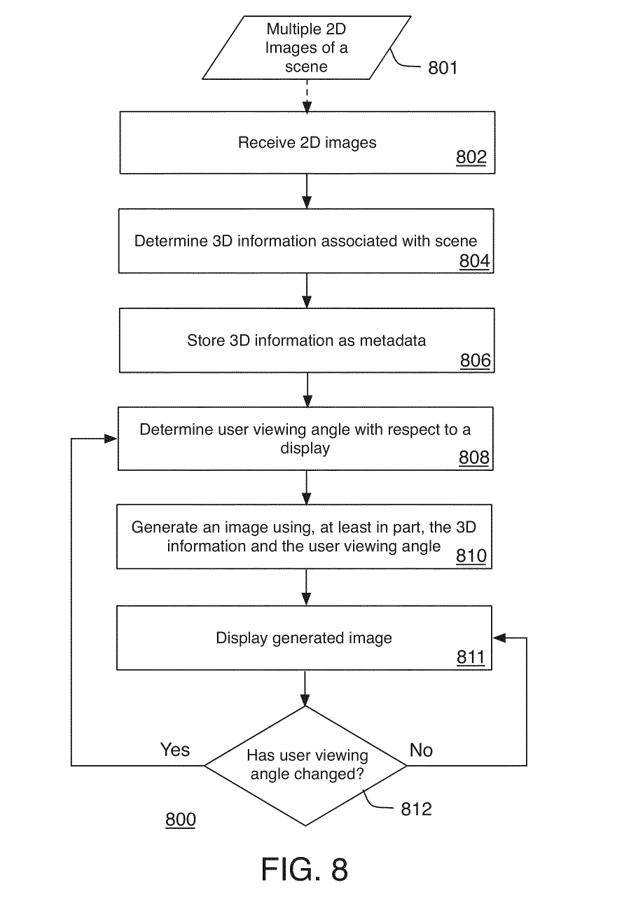

FIG. 8 illustrates a flow diagram of an example parallax viewing process 800 according to various implementations of the present disclosure. Process 800 may include one or more operations, functions or actions as illustrated by one or more of blocks 802, 804, 806, 808, 810 and 812 of FIG. 8.

Process 800 may begin at block 802 where multiple 2D images 801 of a scene may be received as described herein. At block 804, 3D information associated with the scene may be determined. For example, referring to processes 300 and 600, block 804 may include undertaking blocks 304 or 604, respectively, as described herein. The 3D information may then be stored as metadata (block 806) as described herein, and, at block 808, a user viewing angle with respect to a display may be determined as also described herein. At block 810, an image may be generated using, at least in part, the 3D information associated with the scene and the user viewing angle. For example, referring to processes 300 and 600, block 810 may include undertaking blocks 310 or 610, respectively, as described herein. At block 811, the generated image may be displayed. Finally, at block 812, a determination may be made as to whether the user viewing angle has changed. If so, blocks 808 and 810 may be repeated; otherwise, process 800 returns to block 811 to continue displaying the current generated image. In this manner, process 800 may provide for a user-steerable 3D perception or viewing experience.

The systems described above, and the processing performed by them as described herein, may be implemented in hardware, firmware, or software, or any combination thereof. In addition, any one or more features disclosed herein may be implemented in hardware, software, firmware, and combinations thereof, including discrete and integrated circuit logic, application specific integrated circuit (ASIC) logic, and microcontrollers, and may be implemented as part of a domain-specific integrated circuit package, or a combination of integrated circuit packages. The term software, as used herein, refers to a computer program product including a computer readable medium having computer program logic stored therein to cause a computer system to perform one or more features and/or combinations of features disclosed herein.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

What is claimed:

1. A computer-implemented method, comprising:
receiving a plurality of two-dimensional (2D) images of a scene;
determining, in response to the plurality of 2D images, three-dimensional (3D) information associated with the scene;
determining a first user viewing angle with respect to a display; and
presenting, in response to at least the 3D information and the first user viewing angle, a first generated image on the display.

2. The method of claim 1, further comprising:
determining a second user viewing angle with respect to the display, wherein the second user viewing angle is different than the first user viewing angle; and
presenting, in response to at least the 3D information and the second user viewing angle, a second generated image on the display.

3. The method of claim 1, wherein the plurality of 2D images comprise a plurality of video images, and wherein determining 3D information associated with the scene comprises determining a view angle with respect to the scene for each image of the plurality of video images.

4. The method of claim 3, wherein presenting the first generated image on the display comprises determining a video image of the plurality of video images having a view angle nearest to the first user viewing angle.

5. The method of claim 1, further comprising:
storing metadata corresponding to the 3D information.

6. The method of claim 1, wherein determining the first user viewing angle with respect to the display comprises:
using at least one of a front-facing camera, mouse, keyboard or touch screen user control to determine a user's orientation with respect to the display.

7. The method of claim 1, wherein determining 3D information associated with the scene comprises performing stereo reconstruction in response to the plurality of 2D images.

8. The method of claim 7, wherein presenting the first generated image comprises synthesizing the generated image at least in part in response to the 3D information and the first user viewing angle.

9. The method of claim 7, wherein the 3D information comprises at least one of 3D coordinates of the scene or camera pose information associated with the plurality of 2D images.

10. The method of claim 1, wherein the plurality of 2D images comprise images captured by a plurality of imaging devices.

11. The method of claim 10, wherein the plurality of imaging devices comprise at least one of color cameras or color-depth cameras.

12. The method of claim 10, wherein the plurality of imaging devices comprise a high-resolution color camera and a wide field-of-view color camera.

13. An article comprising a computer program product having stored therein instructions that if executed, result in:
receiving a plurality of two-dimensional (2D) images of a scene;
determining, in response to the plurality of 2D images, three-dimensional (3D) information associated with the scene;
determining a first user viewing angle with respect to a display; and
presenting, in response to at least the 3D information and the first user viewing angle, a first generated image on the display.

14. The article of claim 13, the computer program product having stored therein further instructions that, if executed, result in:
determining a second user viewing angle with respect to the display, wherein the second user viewing angle is different than the first user viewing angle; and
presenting, in response to at least the 3D information and the second user viewing angle, a second generated image on the display.

15. The article of claim 13, wherein the plurality of 2D images comprise a plurality of video images, and wherein determining 3D information associated with the scene comprises determining view angle with respect to the scene for each image of the plurality of video images.

16. The article of claim 15, wherein presenting the first generated image on the display comprises determining a video image of the plurality of video images having a view angle nearest to the first user viewing angle.

17. The article of claim the computer program product having stored therein further instructions that, if executed, result in:
storing metadata corresponding to the 3D information.

18. The article of claim 13, wherein determining the first user view angle with respect to the display comprises:
using at least one of a front-facing camera, mouse, keyboard or touch screen user control to determine a user's orientation with respect to the display.

19. The article of claim 13, wherein determining 3D information associated with the scene comprises performing stereo reconstruction in response plurality of 2D images.

20. The article of claim 19, wherein presenting the first generated image comprises synthesizing the generated image at least in part in response to the 3D information and the first user viewing angle.

21. The article of claim 19, wherein the 3D information comprises at least one of 3D coordinates of the scene or camera pose information associated with the plurality of 2D images.

22. A system, comprising:
a processor and a memory coupled to the processor, wherein instructions in the memory configure the processor to:
receive a plurality of two-dimensional (2D) images of a scene;
determine, in response to the plurality of 2D images, three-dimensional (3D) information associated with the scene;
determine a first user viewing angle with respect u a display; and
present, it response to at least the 3D information and the first user viewing angle, a first generated image on the display.

23. The system of claim 22, wherein instructions in the memory further configure the processor to:
determine a second user viewing angle with respect to the display, wherein the second user viewing angle is different than the first user viewing angle; and
present, it response to at least the 3D information and the second user viewing angle, a second generated image on the display.

24. The system of claim 22, wherein the plurality of 2D images comprise a plurality of video images, and wherein instructions that configure the processor to determine 3D information associated with the scene include instructions that configure the processor to determine a view angle with respect to the scene for each image of the plurality of video images.

25. The system of claim 24, wherein instructions that configure the processor to present the first generated image on the display include instructions that configure the processor to determine a video image of the plurality of video images having a view angle nearest to the first user viewing angle.

26. The system of claim 22, further comprising:
at least one of a front-facing camera, mouse, keyboard or touch screen system, and wherein instructions that configure the processor to determine the first user viewing angle with respect to the display include instructions that configure the processor to use the front-facing camera, mouse, keyboard or touch screen user control to determine a user's orientation with respect to the display.

27. The system of claim 22, wherein instructions that configure the processor to determine 3D information associated with the scene include instructions that configure the processor to perform stereo reconstruction in response to the plurality of 2D images.

28. The system of claim 27, wherein instructions that configure the processor to present the first generated image include instructions that configure the processor to synthesize the generated image at least in part in response to the 3D information and the first user viewing angle.

29. The system of claim 27, wherein the 3D information comprises at least one of 3D coordinates of the scene or camera pose information associated with the plurality of 2D images.

30. The system of claim 22, further comprising:
a plurality of imaging devices including at least two of a color camera, a color-depth camera, or a wide field-of-view camera.
